(19) United States
(12) Patent Application Publication
(10) Pub. No.: US 2010/0077899 A1
(43) Pub. Date: Apr. 1, 2010

(54) CORE WIRE CONTACT DETECTION DEVICE

(75) Inventors: Tetsuya YANO, Hyogo (JP); Takashi Ooshima, Hyogo (JP); Nobutaka Ohsumi, Fukuoka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ShinMaywa Industries, Ltd., Takarazuka-shi (JP)

(21) Appl. No.: 12/561,584

(22) Filed: Sep. 17, 2009

(30) Foreign Application Priority Data
Sep. 29, 2008 (JP) 2008-249854

(51) Int. Cl. B26D 7/27; H02G 1/12

(52) U.S. Cl. 83/522.12; 83/522.15; 81/9.4

(57) ABSTRACT

Provided is a core wire contact detection device which detects contact between a strip blade and a core wire when a sheath of an electric wire is stripped by the strip blade. The core wire contact detection device includes a vibration detection unit capable of detecting a vibration in a frequency range including a vibration frequency generated due to the contact between the core wire and the strip blade, and a contact state determination processing unit which determines that the strip blade and the core wire are in contact with each other when an amplitude of the detected vibration exceeds a predetermined threshold value.

### BACKGROUND OF THE INVENTION

1. Field of the Invention

The present invention relates to a technology of detecting contact between a strip blade and a core wire when a sheath of an electric wire is stripped.

2. Description of the Background Art

A sheath of an electric wire is generally stripped using a strip blade. If the strip blade is in contact with the core wire when the strip blade is being engaged in the sheath of the electric wire, the core wire is accidentally damaged.

Conventionally, Japanese Patent Application Laid-Open No. 06-253430 (1994) discloses a technology of detecting contact between the strip blade and the core wire when the sheath of the electric wire is stripped.

In the technology disclosed in Japanese Patent Application Laid-Open No. 06-253430 (1994), whether or not the strip blade and the core wire of the electric wire are in conduction is detected when the sheath of the electric wire is stripped, to thereby detect the contact between the strip blade and the core wire of the electric wire.

### SUMMARY OF THE INVENTION

However, in the technology disclosed in Japanese Patent Application Laid-Open No. 06-253430 (1994), for detecting whether or not the strip blade and the core wire of the electric wire are in conduction, an inspection electrode needs to be electrically connected to the core wire of the electric wire in a portion other than a portion to be stripped. Accordingly, how to establish the connection is a critical issue. In particular, in order to perform the contact detection on the electric wire which is adjusted and cut to a predetermined length, it is required to electrically connect the inspection electrode to the core wire in the respective cut electric wires. Accordingly, there is little likelihood that the technology disclosed in Japanese Patent Application Laid-Open No. 06-253430 (1994) will be realized.

An object of the present invention is therefore to enable detection of contact between a core wire and a strip blade more easily when a sheath of an electric wire is stripped.

In order to solve the above-mentioned problem, according to a first aspect of the present invention, a core wire contact detection device detecting contact between a strip blade and a core wire when a sheath of an electric wire is stripped by the strip blade, includes: a vibration detection unit capable of detecting a vibration in a frequency range including a vibration frequency generated due to the contact between the core wire of the electric wire and the strip blade; and a contact state determination unit determining, when an amplitude of the detected vibration exceeds a predetermined threshold value, that the strip blade and the core wire are in contact with each other based on a vibration detection signal input from the vibration detection unit.

When the strip blade and the core wire are in contact with each other, the amplitude of vibration detected by the vibration detection unit is increased. For this reason, when the amplitude of the detected vibration exceeds the predetermined threshold value, it is possible to detect, by determining that the strip blade and the core wire are in contact with each other, the contact between the core wire and the strip blade with ease when the sheath of the electric wire is stripped.

According to a second aspect of the present invention, the vibration detection unit is a resonance-type acoustic emission sensor having a resonance frequency in a range of 100 kHz to 300 kHz.

In general, a frequency of vibration generated due to contact between a strip blade formed of metal and a core wire formed of metal is easily observed in a range of 100 kHz to 300 kHz. Accordingly, as described in the second aspect, the resonance-type acoustic emission sensor having the resonance frequency in the range of 100 kHz to 300 kHz is used as the vibration detection unit, with the result that the contact between the core wire and the strip blade can be detected more reliably.

According to a third aspect of the present invention, the threshold value is set to a value larger than the vibration detected when the strip blade is cutting into the sheath.

In general, an amplitude of vibration generated due to the contact between the strip blade formed of metal and the core wire formed of metal is larger than an amplitude of vibration generated due to contact between the strip blade formed of metal and the sheath of the electric wire formed of a resin or the like. Accordingly, as described in the third aspect, the value larger than the vibration detected when the strip blade is cutting into the sheath is set as the threshold value, with the result that the contact between the core wire and the strip blade can be detected in a more appropriate manner.

According to a fourth aspect of the present invention, the vibration detection unit is configured so as to be attached in a state of being in contact with the strip blade.

Accordingly, an elastic wave generated due to the contact between the strip blade and the core wire is transmitted to the vibration detection unit via the strip blade more reliably. For this reason, the contact between the core wire and the strip blade can be detected in a more reliable manner.

According to a fifth aspect of the present invention, the core wire contact detection device further includes a pair of the vibration detection units capable of being attached to a pair of the strip blades, respectively.

Accordingly, even when any of the strip blades is in contact with the core wire, the contact therebetween can be detected more reliably.

According to a sixth aspect of the present invention, the core wire contact detection device further includes: a pair of the strip blades capable of cutting into the sheath of the electric wire; and a blade drive unit moving the pair of the strip blades so as to be close to and apart from each other.

The strip blades and the core wire are in contact with each other, whereby the amplitude of the vibration detected by the vibration detection unit is increased. For this reason, when the amplitude of the detected vibration exceeds the predetermined threshold value, it is possible to detect, by determining that the strip blades and the core wire are in contact with each other, the contact between the core wire and the strip blades with ease when the sheath of the electric wire is stripped.

According to a seventh aspect of the present invention, a core wire contact detection method of detecting contact between a strip blade and a core wire when a sheath of an electric wire is stripped by the strip blade, includes the steps of: (a) causing the strip blade to cut into the sheath of the electric wire; (b) detecting a vibration in a frequency range including a vibration frequency generated due to the contact between the core wire of the electric wire and the strip blade in the step (a); and (c) determining that the strip blade and the core wire are in contact with each other when an amplitude of the detected vibration exceeds a predetermined threshold value.

Accordingly, the contact between the core wire and the strip blade can be detected with ease when the sheath of the electric wire is stripped.

According to an eighth aspect of the present invention, the vibration is detected by a resonance-type acoustic emission sensor having a resonance frequency in a range of 100 kHz to 300 kHz in the step (b).

Accordingly, the contact between the core wire and the strip blade can be detected more reliably.

According to a ninth aspect of the present invention, the threshold value of the step (c) is a value larger than an amplitude of a vibration detected when the strip blade is cutting into the sheath.

Accordingly, the contact between the core wire and the strip blade can be detected in a more appropriate manner.

According to a tenth aspect of the present invention, the vibration is detected by a vibration detection unit attached in a state of being in contact with the strip blade in the step (b).

Accordingly, the elastic wave generated due to the contact between the strip blade and the core wire is transmitted to the vibration detection unit via the strip blade more reliably. For this reason, the contact between the core wire and the strip blade can be detected in a more reliable manner.

According to an eleventh aspect of the present invention, a pair of the strip blades are caused to cut into the sheath of the electric wire in the step (a); the vibration is detected for each of the pair of the strip blades in the step (b); and the contact between the strip blade and the core wire is determined when an amplitude of the vibration detected for any of the pair of the strip blades exceeds the predetermined threshold value in the step (c).

Accordingly, even when any of the pair of the strip blades is in contact with the core wire, the contact therebetween can be detected more reliably.

According to a twelfth aspect of the present invention, a core wire contact detection program product being computer-readable and storing a program for, when a sheath of an electric wire is stripped by a strip blade, detecting a vibration in a frequency range including a vibration frequency generated due to contact between a core wire of an electric wire and the strip blade, and determining whether the strip blade and the core wire are in contact with each other based on a vibration detection signal, causes a computer to execute the processings of: (a) comparing an amplitude of the detected vibration with a predetermined threshold value based on the vibration detection signal;

and (b) determining, when the amplitude of the detected vibration exceeds the predetermined threshold value as a result of the comparison of the processing (a), that the strip blade and the core wire are in contact with each other.

Accordingly, the contact between the core wire and the strip blade can be detected with ease when the sheath of the electric wire is stripped.

According to a thirteenth aspect of the present invention, the predetermined threshold value of the process (b) is a value larger than the amplitude of vibration detected when the strip blade is cutting into the sheath.

Accordingly, the contact between the core wire and the strip blade can be detected in a more appropriate manner.

According to a fourteenth aspect of the present invention, the amplitudes of vibrations detected at two points are individually compared with the predetermined threshold value in the processing (a); and it is determined that, when any of the amplitudes of vibrations exceeds the predetermined threshold value, the strip blade and the core wire are in contact with each other in the processing (b).

Accordingly, even when any of the strip blades is in contact with the core wire, the contact therebetween can be detected more reliably.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic side view showing an electric wire strip processing device according to a preferred embodiment;

FIG. 2 is an explanatory view showing strip blades and an electric wire;

FIG. 3 is an explanatory view showing a state in which the strip blades normally cut into the electric wire;

FIG. 4 is an explanatory view showing a state in which the strip blade is in contact with a core wire;

FIG. 5 is a block diagram showing a hardware configuration of a contact state determination processing unit;

FIG. 6 is a functional block diagram of the contact state determination processing unit;

FIG. 7 is a flowchart showing a contact state determination processing performed by the contact state determination processing unit;

FIGS. 8 and 9 are diagrams each showing an example of an amplitude waveform when a strip processing is performed (when stripping is performed normally);

FIGS. 10 to 15 are diagrams each showing an example of an amplitude waveform when the strip processing is performed (when stripping is performed poorly);

FIG. 16 is a diagram of the amplitude waveform of FIG. 9, which is partially enlarged in a time axis;

FIG. 17 is a diagram of the amplitude waveform of FIG. 14, which is partially enlarged in a time axis; and

FIG. 18 is a diagram of the amplitude waveform of FIG. 15, which is partially enlarged in a time axis.

### DESCRIPTION OF THE PREFERRED EMBODIMENT

Hereinafter, an electric wire strip processing device according to a preferred embodiment will be described.

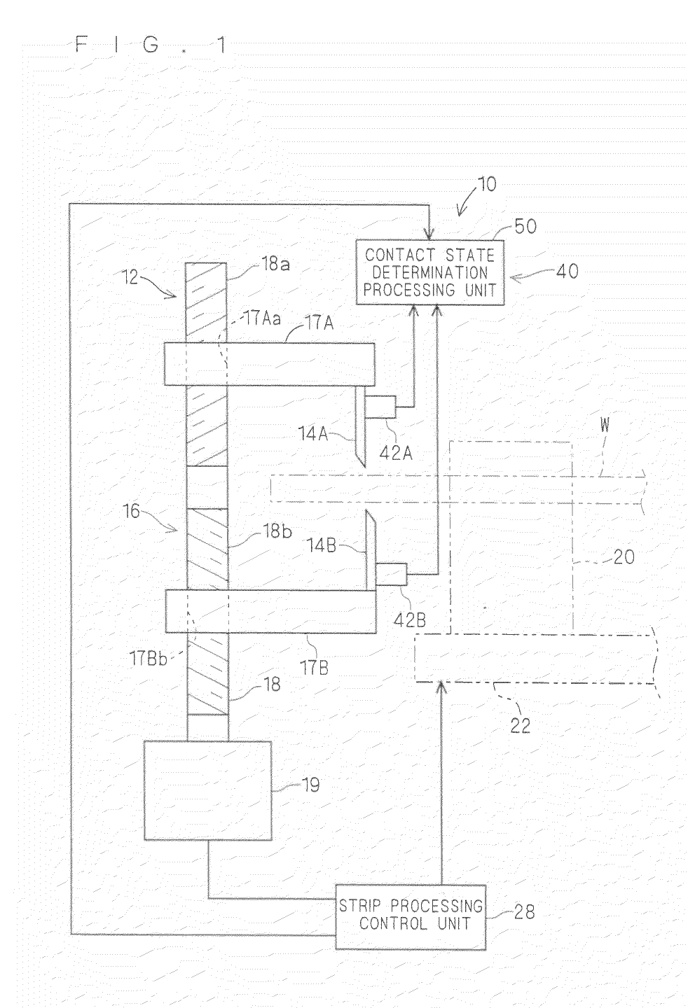

FIG. 1 is a schematic side view showing an electric wire strip processing device 10. The electric wire strip processing device 10 includes an electric wire strip unit 12 and a core wire contact detection device 40.

The electric wire strip unit 12 is a device for peeling a sheath Wb at an end portion of an electric wire W, and includes a pair of strip blades 14A and 14B, a blade drive unit 16, an electric wire holding unit 20 and a sheath removing drive unit 22.

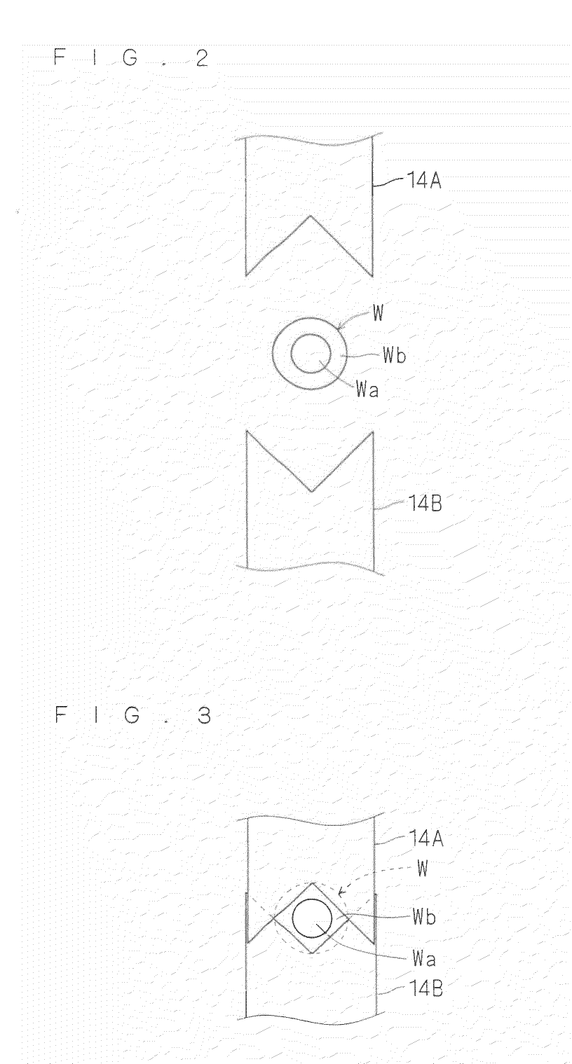

The pair of strip blades 14A and 14B are formed into a blade shape so as to cut into the sheath Wb of the electric wire W. For example, a polyvinyl chloride member is used for the sheath Wb. Here, the pair of strip blades 14A and 14B are formed into a shape of V-shaped blade in which tip portions thereof are dented in a substantially V-shape (see FIG. 2). The parts in shape of the V-shaped blade are formed so as to cut into the sheath Wb of the electric wire W (see FIG. 3). Note that the strip blades 14A and 14B are not limited to have the shape described above, and may have, for example, a shape of a substantially arc-shaped concave blade.

The blade drive unit 16 is configured so as to move the pair of strip blades 14A and 14B to be close to and apart from each other. Here, the blade drive unit 16 includes a pair of blade support units 17A and 17B, a screw unit 18 which movably supports the blade support units 17A and 17B, and a motor 19 which rotates the screw unit 18.

The screw unit 18 is disposed along a predetermined direction (vertical direction in this case), and is rotatably supported about a center axis thereof. A screw groove along a predetermined spiral direction is formed in one end part 18a of the screw unit 18, while another screw groove along a reverse spiral direction is formed in the other end part 18b of the screw unit 18.

The motor 19 is formed of a motor capable of performing drive control on a rotational amount of a servomotor or the like, and is disposed so that a rotational drive force thereof can be transmitted to the screw unit 18. In this case, a drive shaft unit of the motor 19 is directly coupled to the screw unit 18. The screw unit 18 is configured so as to rotate in both forward and reverse directions in accordance with rotation drive of the motor 19.

The pair of blade support units 17A and 17B are formed of an elongated member, and the strip blades 14A and 14B are fixedly supported at tip portions thereof, respectively. A screwing unit 17Aa, which can be screwed to the one end part 18a of the screw unit 18, is formed at a base end portion of the blade support unit 17A, whereas a screwing unit 17B, which can be screwed to the other end part 18b of the screw unit 18, is formed at a base end portion of the blade support unit 17B. The screwing unit 17Aa of the blade support unit 17A is screwed to the one end part 18a of the screw unit 18, and the screwing unit 17Ba of the blade support unit 17B is screwed to the other end part 18b of the screw unit 18 in a state of causing the tip portions of the pair of strip blades 14A and 14B to be opposed to each other. Rotation of the motor 19 is controlled in the forward direction or the reverse direction in this state, whereby the pair of strip blades 14A and 14B can be moved close to or apart from each other.

It goes without saying that the blade drive unit is not limited to be configured as described above, and may be configured to be driven by an air cylinder, an oil hydraulic cylinder, a linear motor or the like. Alternatively, the blade drive unit may be configured to individually drive the pair of strip blades 14A and 14B.

The electric wire holding unit 20 is configured so as to hold the electric wire W in a state where an end portion of the electric wire W is disposed between the pair of strip blades 14A and 14B. As the electric wire holding unit 20 as described above, for example, there can be adopted, for example, a well-known chuck mechanism which opens and closes a pair of holding claws by driving of an actuator of the air cylinder, the oil hydraulic cylinder or the like. In other words, a configuration capable of holding an electric wire can be adopted.

The sheath removing drive unit 22 is configured as a mechanism which provides a movement of removing the sheath Wb at the end portion of the electric wire W by moving the pair of strip blades 14A and 14B and the electric wire holding unit 20 in a spaced direction. Here, the sheath removing drive unit 22 is formed of, for example, the actuator of the air cylinder, oil hydraulic cylinder or the like, and is configured to move the electric wire holding unit 20 in a direction so as to be apart from the pair of strip blades 14A and 14B.

The electric wire strip unit 12 strips the sheath Wb at the end portion of the electric wire W under control of a strip processing control unit 28 as follows.

That is, in the state where the pair of strip blades 14A and 14B are moved to be apart from each other, the electric wire W is held by the electric wire holding unit 20 such that the end portion of the electric wire W is disposed between the pair of stripe blades 14A and 14B (see FIG. 2). The pair of strip blades 14A and 14B are moved close to each other by driving of the blade drive unit 16 in this state. Then, the parts in shape of the V-shaped blade are cutting into the sheath Wb in the state where a core wire Wa is disposed in a region surrounded by the parts in shape of the V-shaped blade of the pair of strip blades 14A and 14B (see FIG. 3). In this manner, the pair of strip blades 14A and 14B and the electric wire holding unit 20 are moved 22 in the spaced direction by driving of the sheath removing drive unit in the state where the parts in shape of the V-shaped blade are cutting into the sheath Wb. As a result, parts of the sheath Wb which are located on the tip side with respect to the parts in shape of the V-shaped blade are removed from the electric wire W held by the electric wire holding unit 20, whereby the core wire Wa is exposed at the end portion of the electric wire W. Note that an operation ON signal is output from the strip processing control unit 28 as a signal indicating an operation timing of the electric wire strip unit 12, and then is input to a contact state determination processing unit 50 which will be described below.

Here, in some cases, the pair of strip blades 14A and 14B are accidentally brought into contact with the core wire Wa when the pair of strip blades 14A and 14B cut into the sheath Wb (see FIG. 4). When the strip blades 14A and 14B are brought into contact with the core wire Wa, the core wire is, for example, damaged or cut, which may cause poor contact, disconnection or the like.

The core wire contact detection device 40 is configured to detect contact between the strip blades 14A and 14B and the core wire Wa when the sheath Wb of the electric wire W is stripped by the strip blades 14A and 14B as described above.

That is, the core wire contact detection device 40 includes vibration detection units 42A and 42B and a contact state determination processing unit 50.

The vibration detection unit 42A (or 42B) is configured so as to detect a vibration in a frequency range including a vibration frequency generated as a result of the contact between the core wire Wa and the strip blade 14A (or 14B).

That is, in a case where the core wire Wa and the strip blade 14A (or 14B) are brought into contact with each other and accordingly the core wire Wa is broken, for example, is damaged, an acoustic emission (AE) wave is generated by AE. For this reason, the vibration detection unit 42A (or 42B) is configured so as to detect a vibration in a frequency range including a vibration frequency of the AE wave generated due to the contact between the core wire Wa and the strip blade 14A (or 14B). Note that in the present invention, the vibration frequency generated due to the contact between the core wire Wa and the strip blade 14A (or 14B) refers to a vibration frequency in a range of the frequencies generated due to the contact, or a particular vibration frequency generated due to the contact.

The core wire Wa is typically formed of metal, and the strip blade 14A (or 14B) is formed of metal as well. The AE wave generated due to metal breakdown has little attenuation in a range of 100 kHz to 300 kHz, and therefore is easily observed. For this reason, the vibration detection unit 42A (or 42B) is preferably capable of detecting vibrations in frequency ranges which partially or entirely overlap each other with respect to the range of 100 kHz to 300 kHz. More preferably, the vibration detection unit 42A (or 42B) is capable of detecting a vibration in the range of 100 kHz to 300 kHz with high sensitivity. More specifically, the vibration detection unit 42A (or 42B) is a resonance-type AE sensor having a resonance frequency in the range of 100 kHz to 300 kHz. Still more preferably, the vibration detection unit 42A (or 42B) is a resonance-type AE sensor having a resonance frequency of 200 kHz.

The vibration detection unit 42A is attached and fixed so as to be in contact with the strip blade 14A. More specifically, the vibration detection unit 42A is attached and fixed so that a detection surface of the vibration detection unit 42A is in contact with a main surface of the strip blade 14A. In the same manner, the vibration detection unit 42B is attached and fixed so as to be in contact with the strip blade 14B. The vibration detection unit 42A and the vibration detection unit 42B can be attached and fixed with various attachment structures of screw tightening, bonding or the like. The vibration detection unit 42A and the vibration detection unit 42B may be attached to such positions that do not hinder the strip operation. The vibration detection units 42A and 42B are attached and fixed in a state of being in contact with the strip blades 14A and 14B, respectively, whereby it is possible to detect the vibration of the AE wave generated due to the contact between the core wire Wa and the strip blade 14A (or 14B) with more reliably.

Vibration detection signals from the vibration detection units 42A and 42B are input to the contact state determination processing unit 50 as, for example, an analog signal having voltage in accordance with the detected vibration.

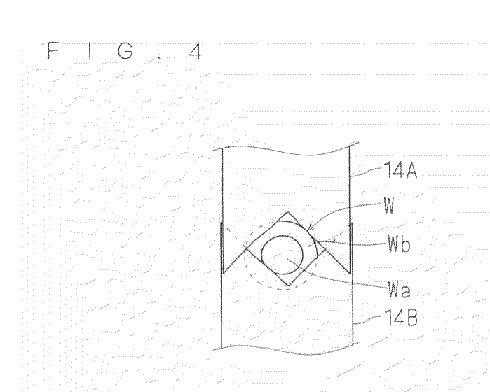

FIG. 5 is a block diagram showing a hardware configuration of the contact state determination processing unit 50. The contact state determination processing unit 50 is configured so as to execute, when the amplitude of the detected vibration exceeds the predetermined threshold value, the processing executed by the contact state determining unit of determining that the strip blades 14A and 14B and the core wire Wa are in contact with each other based on the detection signals input from the vibration detection units 42A and 42B.

More specifically, the contact state determination processing unit 50 is formed of a typical computer in which a CPU 52, a ROM 53, a RAM 54, an external storage device 55 and the like are interconnected via a bus line 51. The ROM 53 stores a basic program and the like, and the RAM 54 is provided as a working area when the CPU 52 performs a predetermined processing. The external storage device 55 is formed of a non-volatile storage device such as a flash memory or a hard disc device. The external storage device 55 stores a contact detection program 55a for performing a core wire contact detection processing which will be described below. The contact state determination processing unit 50 is configured such that various functions of detecting the contact between the strip blades 14A and 14B and the core wire Wa are realized when the CPU 52 being as a main control unit performs arithmetic processing in accordance with the contact detection program 55a, which will be described below. The contact detection program 55a is normally stored in the external storage device 55 in advance, and may be provided in a state of being recorded in a computer-readable recording medium such as a CD-ROM, a DVD-ROM and an external flush memory. Alternatively, the contact detection program 55a may be provided by being downloaded from an external server via a network and may be stored in the external storage device 55 in an additional or changeable manner.

Moreover, the external storage device 55 stores a threshold value serving as a reference when the core wire contact detection processing is performed. The threshold value will be described below.

In the contact state determination processing unit 50, a detection signal input circuit unit 56, an output circuit unit 57a, an input circuit unit 57b, an input unit 58 and a display unit 59 are connected to the bus line 51 as well.

The detection signal input circuit unit 56 is constituted of an amplifier circuit, an AD conversion circuit and the like, and is configured to, when the vibration detection signals obtained by the vibration detection units 42A and 42B are input as analog signals, amplify the analog signals and then convert the amplified analog signals into digital signals. The vibration detection signals converted into digital signals by the detection signal input circuit unit 56 are, for example, stored as data in which amplitude values are aligned in time order in the RAM 54 or the external storage device 55, and then are used in the contact detection processing which will be described below.

The output circuit unit 57a outputs a control signal or the like to other device under control of the CPU 52. The input circuit unit 57b receives various signals from outside, and in this case, receives the operation ON signal from the strip processing control unit 28.

The input unit 58 is constituted of various switches, a touch panel and the like, and is configured so as to receive various instructions to the contact state determination processing unit 50 in addition to an instruction for input setting of the threshold value.

The display unit 59 is constituted of a liquid crystal display, a light and the like, and is configured so as to display various information such as a determination result of a contact state under the control of the CPU 52.

FIG. 6 is a functional block diagram of the contact state determination processing unit 50. As shown in FIG. 6, the contact state determination processing unit 50 has functions as a comparator circuit unit 52a and a determination unit 52b. The respective functions are realized when the CPU 52 performs the predetermined arithmetic processing in accordance with the contact detection program 55a.

The comparator circuit unit 52a compares an amplitude of the detected vibration with the predetermined threshold value based on the input vibration detection signal. This comparison is performed on pieces of amplitude data of vibrations which continue in time order. Then, the comparator circuit unit 52a provides the comparison result to the determination unit 52b.

When it is determined that the amplitude of the detected vibration exceeds the predetermined threshold value based on the comparison result obtained by the comparator circuit unit 52a, the determination unit 52b determines that the strip blade 14A and the core wire Wa are in contact with each other, and then outputs the determination result. The determination result is used in display of the display unit 59. Whether or not the strip blade 14B and the core wire Wa are in contact with each other is also determined by a similar function.

Note that a partial or entire function performed by the contact state determination processing unit 50 may be realized by hardware such as a dedicated logic circuit.

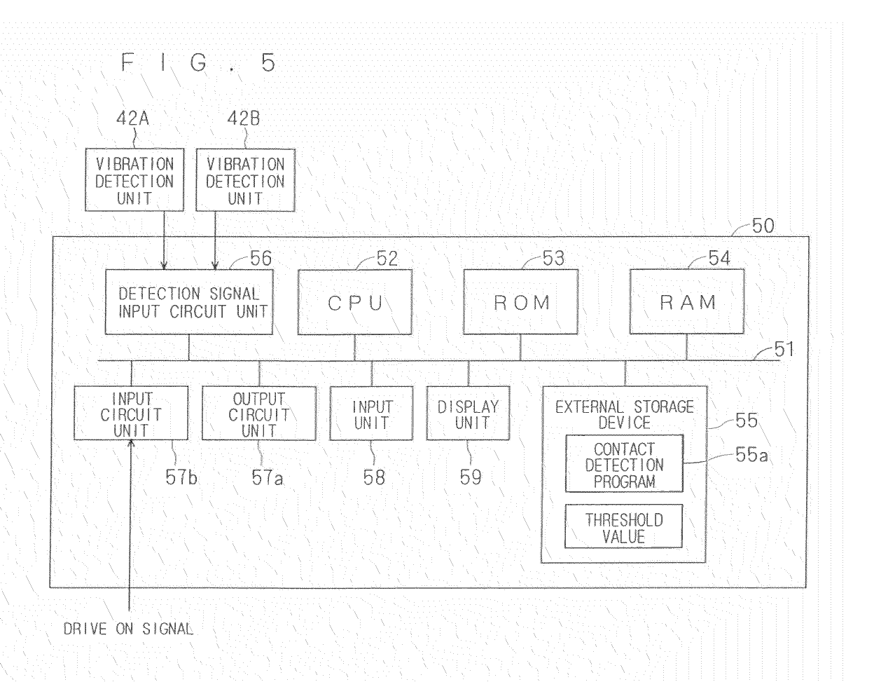

FIG. 7 is a flowchart showing a contact state determination processing performed by the contact state determination processing unit 50.

After the start of the contact state determination processing, the contact state determination processing unit 50 determines whether or not the drive ON signal has been input from the electric wire strip unit 12 in Step S1. When it is determined in Step S1 that the drive ON signal has not been input, the processing of Step S1 is repeated. When the strip processing is started by the electric wire strip unit 12 and the drive ON signal is input, it is determined in Step S1 that the drive ON signal has been input, whereby the process proceeds to Step S2.

In Step S2, the contact state determination processing unit 50 obtains the vibration amplitude data of the strip blades 14A and 14B. For example, in a period from the input of the drive ON signal to the end of the strip processing, the vibration detection signals from the vibration detection units 42A and 42B are sampled to obtain the vibration amplitude data. The process proceeds to Step S3 after Step S2.

In Step S3, the contact state determination processing unit 50 determines whether or not a value of amplitude exceeds the predetermined threshold value as to the vibration amplitude data of the strip blade 14A. When it is determined that the value of amplitude does not exceed the predetermined threshold value, the process proceeds to Step S4.

In Step S4, the contact state determination processing unit 50 determines whether or not the value of amplitude exceeds the predetermined threshold value as to the vibration amplitude data of the strip blade 14. When it is determined that the value of amplitude does not exceed the predetermined threshold value, the process returns to Step S1, and the above-mentioned processings are repeated.

When it is determined in Steps S3 and S4 that the value of amplitude exceeds the predetermined threshold value, the process proceeds to Step S5.

In Step S5, the contact state determination processing unit 50 determines that there is the contact, and then outputs a determination result thereof. Display indicating that there is the contact is made in the display unit 59 based on the determination result. Alternatively, a signal indicating that the strip processing is stopped is provided to the electric wire strip unit 12 based on the determination result. Accordingly, the electric wire strip unit 12 temporarily stops the strip processing in response to the signal.

Note that in a case where the value of amplitude and the predetermined threshold value are equal to each other in Steps S3 and S4, the process may proceed to any processing of a branch destination.

Further, the processings of Steps S3 and S4 may be performed in a reverse order or executed in parallel.

Here, a preferred setting example of the threshold value will be described with reference to an amplitude waveform of vibration occurring in the strip processing.

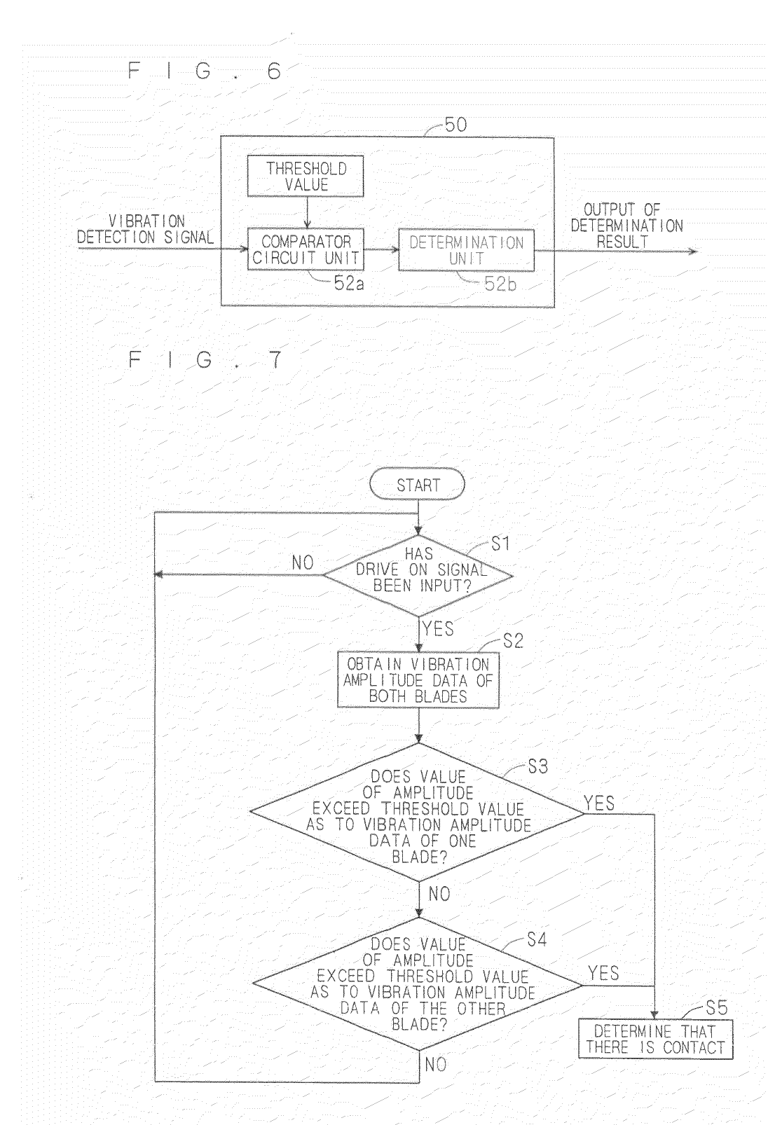

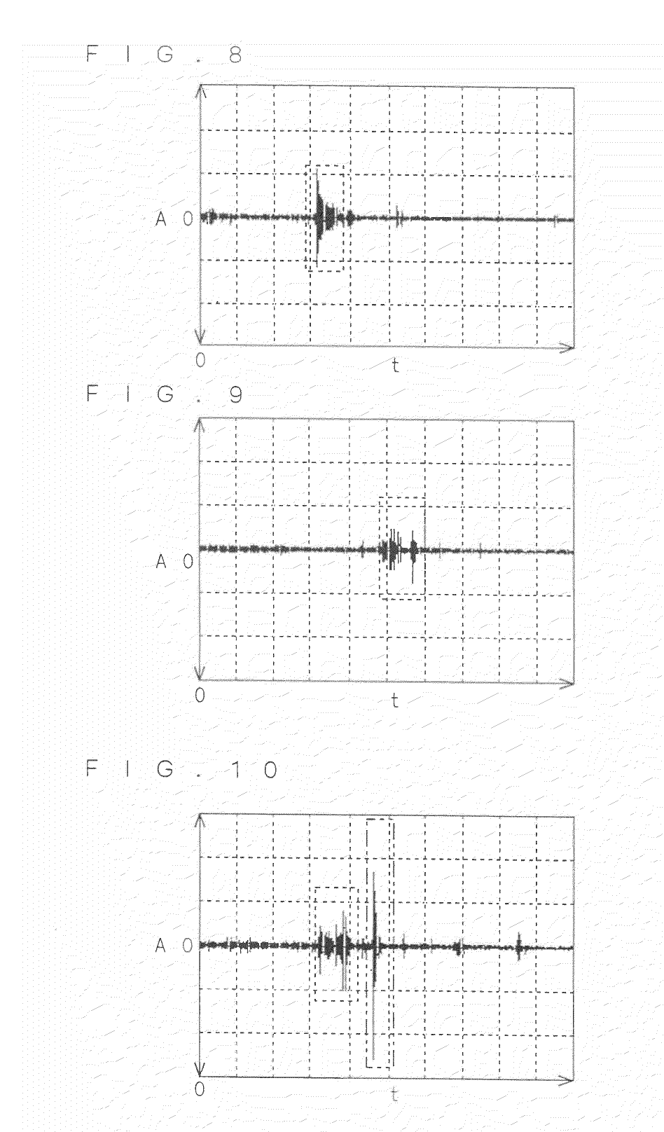

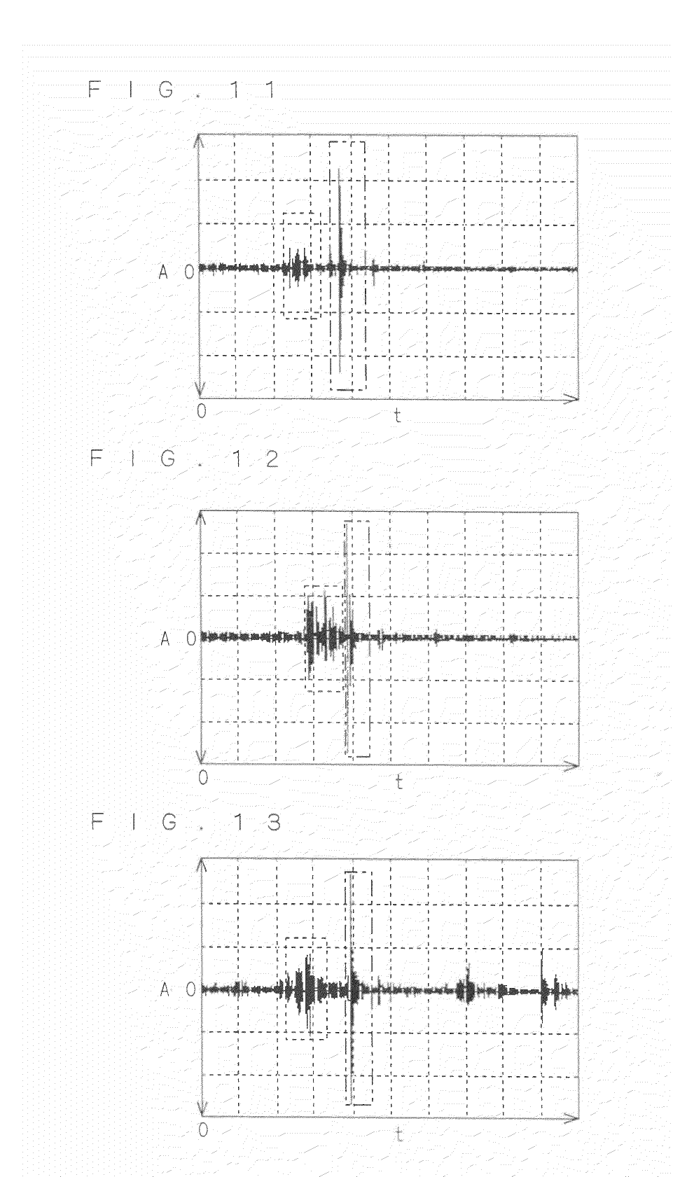

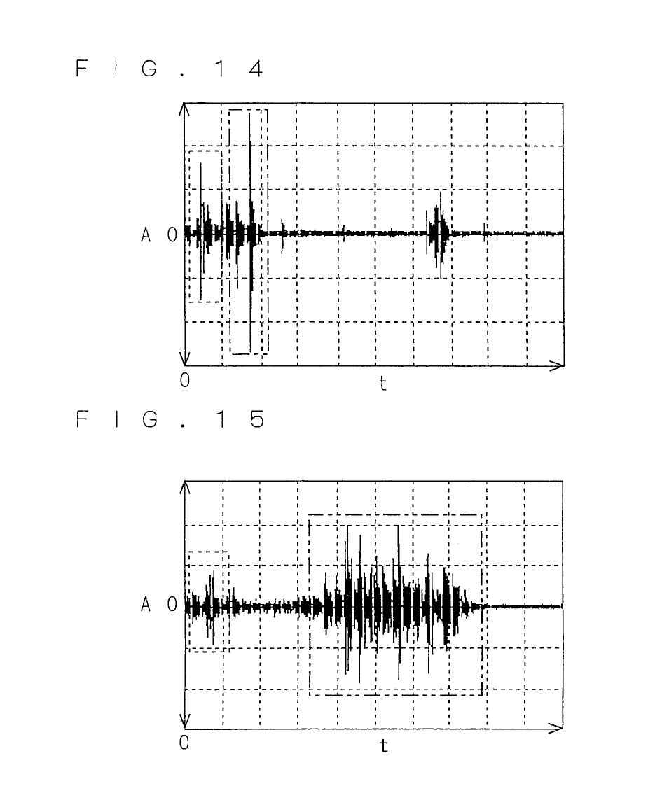

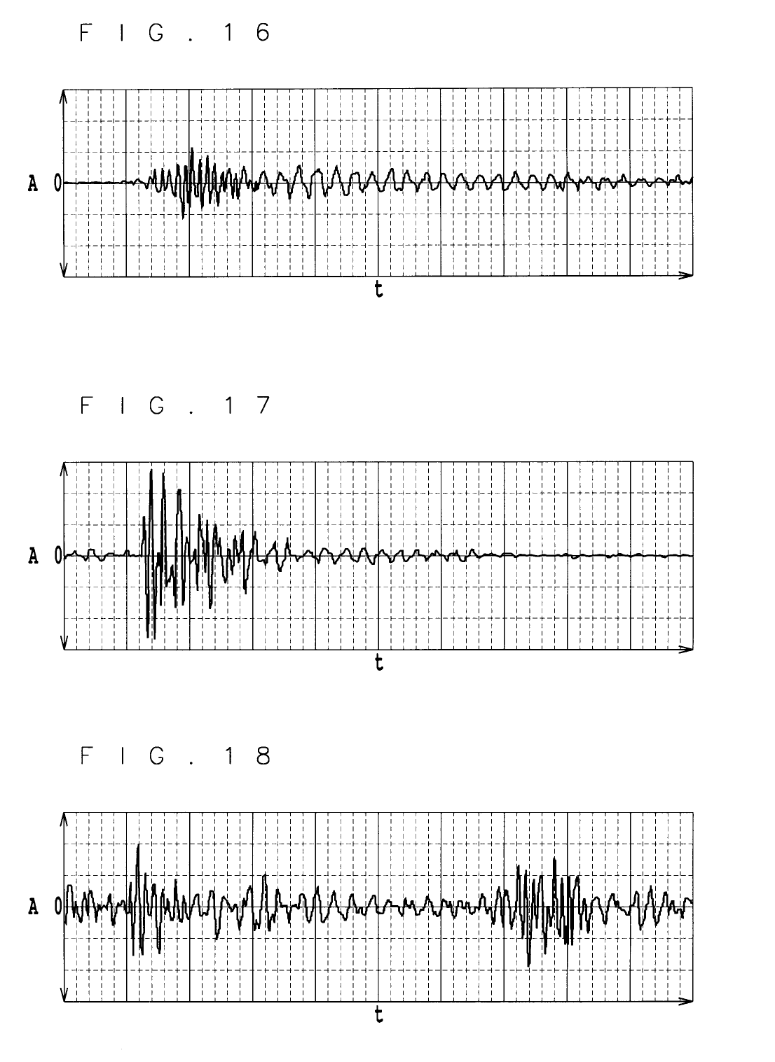

FIG. 8 and FIG. 9 each show a relationship (amplitude waveform) between a time t after the start of the strip processing and an amplitude A in a case where stripping is performed normally, that is, in a case where only the sheath Wb is removed sufficiently without damaging or cutting the core wire Wa. FIG. 10 to FIG. 12 each show an amplitude waveform in a case where the core wire Wa is damaged in the strip processing. FIG. 13 shows an amplitude waveform in a case where the strip blades 14A and 14B bite with the core wire Wa in the strip processing, FIG. 14 shows an amplitude waveform in a case where the core wire Wa is partially broken in the strip processing, and FIG. 15 shows an amplitude waveform in a case where the core wire Wa is completely broken in the strip processing. Note that in the respective figures, parts of waveforms observed when the strip blades 14A and 14B cut into the sheath Wb are surrounded by a dashed line, and parts of waveforms observed when the strip blades 14A and 14B are in contact with or cutting into the core wire Wa are surrounded by a chain double-dashed line. Further, FIG. 16 shows the part of waveform observed when the strip blades 14A and 14B cut into the sheath Wb in FIG. 9, which is enlarged in a time axis. FIG. 17 shows the part of waveform observed when the strip blades 14A and 14B are cutting into the core wire Wa in FIG. 14, which is enlarged in a time axis. FIG. 18 shows the part of waveform observed when the strip blades 14A and 14B are cutting into the core wire Wa in FIG. 15, which is enlarged in a time axis.

As shown in those figures, a larger amplitude is observed when the strip blades 14A and 14B are in contact with or cutting into the core wire Wa. Therefore, it is possible to effectively determine whether or not the strip blades 14A and 14B and the core wire Wa are in contact with each other by estimating, among a plurality of experimental results, a value of amplitude which is assumed to be observed when the strip blades 14A and 14B are in contact with or cutting into the core wire Wa, and then setting the estimated value as the threshold value in the processing described above.

In particular, as is apparent from the respective figures, the amplitude is increased even when the strip blades 14A and 14B are cutting into the sheath Wb. However, a larger amplitude is observed when the strip blades 14A and 14B are in contact with or cutting into the core wire Wa. That is, it is found that the maximum value of amplitude observed when the strip blades 14A and 14B are in contact with or cutting into the core wire Wa is larger than the maximum value of amplitude observed when the strip blades 14A and 14B are cutting into the sheath Wb.

Accordingly, it is found that a value larger than the maximum value of amplitude observed when the strip blades 14A and 14B are cutting into the sheath Wb is preferably set as the threshold value.

The threshold value as described above may be set experimentally or empirically because, in actuality, the threshold value depends on, for example, materials and shapes of the core wire Wa, the sheath Wb and the strip blades 14A and 14B.

According to the core wire contact detection device, the electric wire strip processing device, the core wire contact detection method and the core wire contact detection program which are configured as described above, an amplitude of vibration detected by the vibration detection units 42A and 42B is increased when the strip blades 14A and 14B and the core wire Wa are in contact with each other. For this reason, when the amplitude of the detected vibration exceeds the predetermined threshold value, the strip blades 14A and 14B and the core wire Wa are determined to be in contact with each other, with the result that the contact therebetween can be detected with ease.

In particular, the strip blade needs to be insulated from other parts in the case of the conventional technology, but this embodiment has an advantage in that there is no need to take a countermeasure against insulation as described above.

Further, the vibration detection units 42A and 42B are attached in the state of being in contact with the strip blades 14A and 14B, respectively, and hence elastic waves generated due to the contact between the strip blades 14A and 14B and the core wire Wa are transmitted to the vibration detection units 42A and 42B via the strip blades 14A and 14B without fail. Accordingly, the contact between the core wire Wa and the strip blades 14A and 14B can be detected more reliably.

It goes without saying that whether or not there is the contact may be determined by attaching the vibration detection unit to one of the strip blades 14 and 14B.

While the invention has been shown and described in detail, the foregoing description is in all aspects illustrative and not restrictive. It is therefore understood that numerous modifications and variations can be devised without departing from the scope of the invention.

What is claimed is:

1. A core wire contact detection device detecting contact between a strip blade and a core wire when a sheath of an electric wire is stripped by the strip blade, comprising:
a vibration detection unit capable of detecting a vibration in a frequency range including a vibration frequency generated due to the contact between the core wire of the electric wire and the strip blade; and
a contact state determination unit determining, when an amplitude of the detected vibration exceeds a predetermined threshold value, that the strip blade and the core wire are in contact with each other based on a vibration detection signal input from said vibration detection unit.

2. The core wire contact detection device according to claim 1, wherein said vibration detection unit is a resonance-type acoustic emission sensor having a resonance frequency in a range of 100 kHz to 300 kHz.

3. The core wire contact detection device according to claim 1, wherein said threshold value is set to a value larger than the vibration detected when the strip blade is cutting into the sheath.

4. The core wire contact detection device according to claim 1, wherein said vibration detection unit is configured so as to be attached in a state of being in contact with the strip blade.

5. The core wire contact detection device according to claim 1, further comprising a pair of said vibration detection units capable of being attached to a pair of said strip blades, respectively.

6. The core wire contact detection device according to claim 1, further comprising:
a pair of the strip blades capable of cutting into the sheath of the electric wire; and
a blade drive unit moving said pair of the strip blades so as to be close to and apart from each other.

7. A core wire contact detection method of detecting contact between a strip blade and a core wire when a sheath of an electric wire is stripped by the strip blade, the method comprising the steps of:
(a) causing the strip blade to cut into the sheath of the electric wire;
(b) detecting a vibration in a frequency range including a vibration frequency generated due to the contact between the core wire of the electric wire and the strip blade in said step (a); and
(c) determining that the strip blade and the core wire are in contact with each other when an amplitude of the detected vibration exceeds a predetermined threshold value.

8. The core wire contact detection method according to claim 7, wherein the vibration is detected by a resonance-type acoustic emission sensor having a resonance frequency in a range of 100 kHz to 300 kHz in said step (b).

9. The core wire contact detection method according to claim 7, wherein the predetermined threshold value of said step (c) is a value larger than the amplitude of vibration detected when the strip blade is cutting into the sheath.

10. The core wire contact detection method according to claim 7, wherein the vibration is detected by a vibration detection unit attached in a state of being in contact with the strip blade in said step (b).

11. The core wire contact detection method according to claim 7, wherein:
a pair of said strip blades are caused to cut into said sheath of said electric wire in said step (a);
the vibration is detected for each of the pair of said strip blades in said step (b); and
the contact between the strip blade and the core wire is determined when an amplitude of the vibration detected for any of the pair of said strip blades exceeds the predetermined threshold value in said step (c).

12. A core wire contact detection program product being computer-readable and storing a program for, when a sheath of an electric wire is stripped by a strip blade, detecting a vibration in a frequency range including a vibration frequency generated due to contact between a core wire of an electric wire and the strip blade, and determining whether the strip blade and the core wire are in contact with each other based on a vibration detection signal,
the core wire contact detection program product causing a computer to execute the processings of:
(a) comparing an amplitude of the detected vibration with a predetermined threshold value based on said vibration detection signal; and
(b) determining, when the amplitude of the detected vibration exceeds the predetermined threshold value as a result of the comparison of said processing (a), that the strip blade and the core wire are in contact with each other.

13. The core wire contact detection program product according to claim 12, wherein the predetermined threshold value of said processing (b) is a value larger than the amplitude of the vibration detected when the strip blade is cutting into the sheath.

14. The core wire contact detection program product according to claim 12, wherein:
the amplitudes of vibrations detected at two points are individually compared with the predetermined threshold value in said processing (a); and
it is determined, when any of the amplitudes of vibrations exceeds the predetermined threshold value, that the strip blade and the core wire are in contact with each other in said processing (b).
